(19) United States
(12) Patent Application Publication
(10) Pub. No.: US 2004/0014007 A1
(43) Pub. Date: Jan. 22, 2004

(54) Bridge assembly for positioning a denture

(76) Inventors: Chin-Sheng Lee, Taichung City (TW); Jenny Lee, Taichung City (TW); Jin-Fung Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/338,860

(22) Filed: Jan. 9, 2003

(30) Foreign Application Priority Data
Jul. 19, 2002 (TW) 091116407

(51) Int. Cl. A61C 13/12

(52) U.S. Cl. 433/181; 433/183

(57) ABSTRACT

An assembly of denture bridge includes a lingual restoration and a buccal restoration so as to install a denture to the place where a tooth is missing. The buccal restoration has two wings on two ends thereof so as to contact the inside of the nature teeth and the lingual restoration is formed according the mesio-distal side of the lingual side and the occusal surface. Two lingual restorations are connected to the buccal restoration by a screw so as to secured onto the nature teeth. The nature teeth need not to be remove a lot and the denture can be set within a short period of time. The patient needs not to wear a temporary grown.

### FIELD OF THE INVENTION

The present invention relates to a bridge assembly that is positioned from the lingual side and the buccal side so that the denture can be well positioned regardless of the shape or form of the nature teeth besides the missing position.

### BACKGROUND OF THE INVENTION

A conventional way to positioning a denture 11 is shown in FIG. 1 and has to remove most part of the nature teeth 10 on two sides of the missing position to be parallel or dual-inclined surface form such that the abutment dentures 12 may be mounted to the nature teeth 10 and the denture 11 is positioned at the missing position. The abutment dentures 12 each have a recess 121 so as to mount onto the trimmed nature teeth 10. The conventional way has to remove part of the nature teeth 10 and this takes a lot of time and effort for the dentists. A local anesthesia is required during the process to trim the nature teeth 10. Of more importance is that the removal of the nature teeth 10 damages the nature teeth 10. Besides, a teeth mold is first made according to which the denture is made. A period of waiting time is suffered and a temporary grown is used so as to prevent the trimmed nature teeth 10 from being damaged. Furthermore, it is costly for making the denture and the abutment dentures.

Another way is to employs a linguobuccal clasp rest which is positioned by a screw. Nevertheless, the clasp rest is only positioned by the screws contacting the nature teeth on the sides of the clasp rest. Therefore, the clasp rest is not secured in the vertical direction so that the screws could be broken when the maxillary mandibles are moved toward each other. The loosened clasp rest may drop downward or dragged to hurt the periodontal membrance, the PDL, and the gingiva. The clasp rest is positioned from the buccal side and the lingual side so that it protrudes form the out sides of the nature tooth that was there. Therefore, the occusal surface of the maxillary mandibles and the buccolingual do not contact the denture in a normal way. The denture is positioned by the splints at the front and the rear sides thereof so that there is no proximal interspace at the nature teeth beside the denture so that the food debris cannot be removed by using the tongue. This results in bad breath.

Yet another way is disclosure in WO909909 and has to plant the residual root which is positioned by screws. The sides of the nature teeth are to be damaged so as to be engaged with the screws and this way is not satisfied by the market.

### SUMMARY OF THE INVENTION

The primary object of the present invention is to provide a bridge assembly that is secured by using a lingual restoration and a buccal restoration. The buccal restoration has two wings at two ends thereof so as to contact the two inner sides of the nature teeth on the two sides of the bridge. The lingual restoration has a undercut which is defined corresponding to the lingual surface, mesio-distal side and occusal surface of the nature teeth on the two sides of the bridge. A screw is used to connect the lingual restoration and the buccal restoration so that the lingual restoration and the buccal restoration can be mounted to the nature teeth without too much removal of the nature teeth.

Another object of the present invention is to provide a bridge assembly that the patient needs no local anesthesia and the no long-term wearing of temporary grown is required. By this bridge assembly, the patient feels no pain and the bridge assembly is easily to be made.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional way to install a denture and the two nature teeth are trimmed;

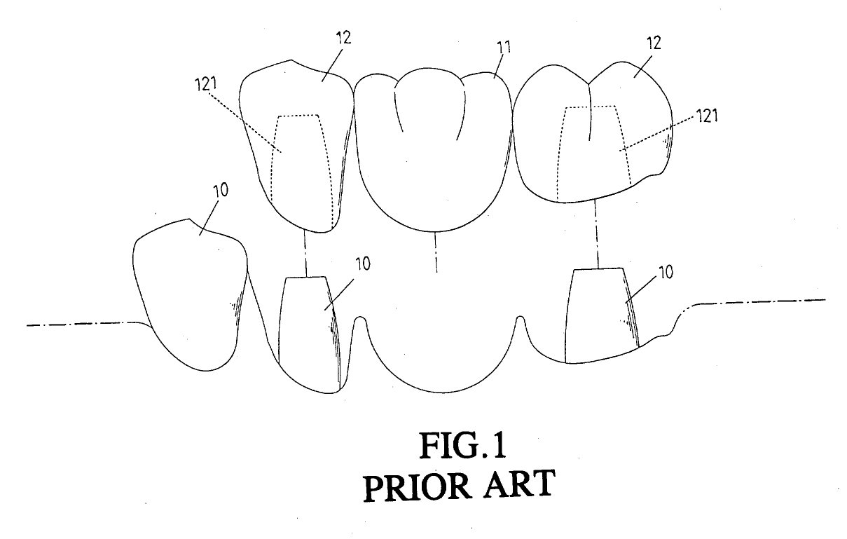

FIG. 2 is an exploded view to show the denture for the maxillary mandible of the present invention;

FIG. 3 is another embodiment of the denture for the maxillary mandible of the present invention;

FIG. 4 an exploded view to show yet another embodiment of the denture for the maxillary mandible of the present invention;

FIG. 5 is a perspective view to show the denture for the maxillary mandible of the present invention as shown in FIG. 4;

FIG. 6 is another embodiment of the denture for the maxillary mandible of the present invention;

FIG. 7 is a perspective view to show the denture for the maxillary mandible of the present invention, and

FIG. 8 shows the arrangement of human teeth.

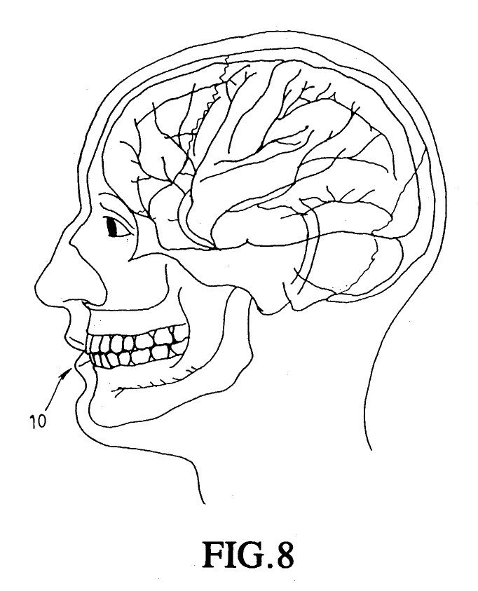

### DETAILED DESCRIPTION OF THE PREFERRED EMBODIMENT

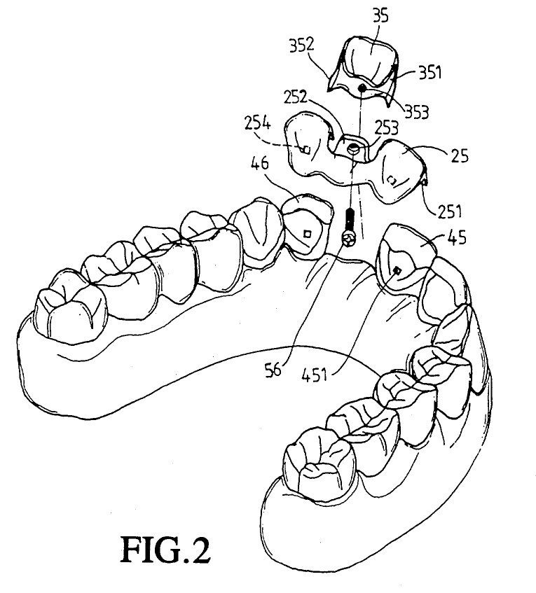

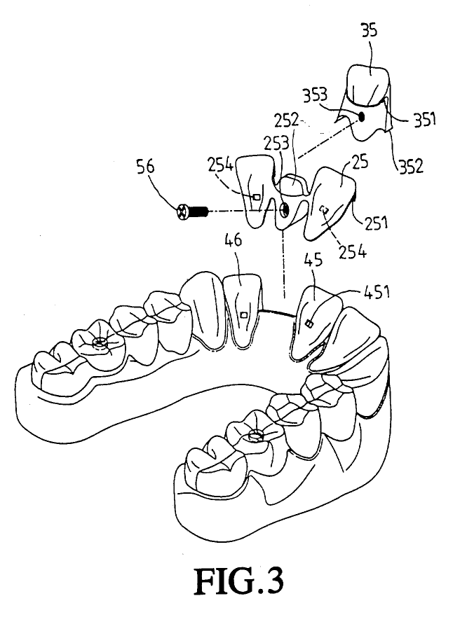

Referring to FIGS. 2 and 3, the bridge assembly of the present invention comprises two lingual restorations 25 and a buccal restoration 35. A connection portion 252 is connected between the two lingual restorations 25 and each lingual restoration 25 has a undercut 251 so as to be mounted onto the nature teeth 45 and 46 located on two sides of the missing position. The shape of the undercut 251 is complimentary to the shape of the contour of the nature teeth 45, 46 and mesio-distal side. An engaging notch 451/452 is defined in each nature tooth 45, 46 because the front occusal surface is inclined and is engaged with an engaging member 254/255 in each lingual restoration 25. This engagement dispenses the force when using the denture and prevents from hurting the gingiva. A first hole 253 is defined in the connection portion 252 between the lingual restorations 25. A positioning groove 351 is defined in the buccal restoration 35 and is engaged with the connection portion 252 of the lingual restorations 25. Two wings 352 are formed at two sides of the buccal restoration 35 so as to be engaged with two sides of the nature teeth 45, 46. The positioning groove 351 further includes a threaded hole 353 such that a screw 56 extends through the first hole 253 and is engaged with the threaded hole 353 to connect the two items, A resin filling can be used to fill the notch of the connection area.

As shown in FIG. 3 which shows the bridge assembly similar that shown in FIG. 2. The only difference is that the first hole 253 is located at the lower edge of the connection portion 252 of the lingual restorations 25. The threaded hole 353 of the buccal restoration 35 is located corresponding to the position of the first hole 253.

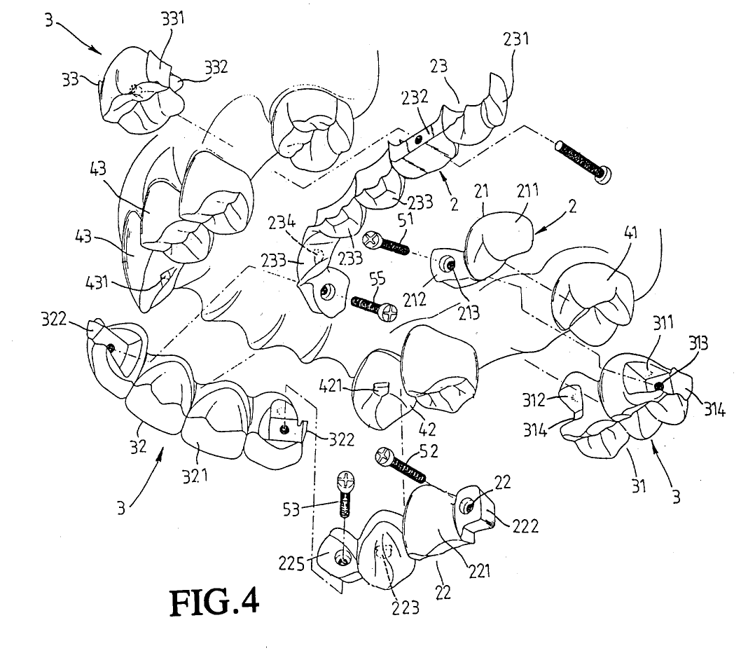

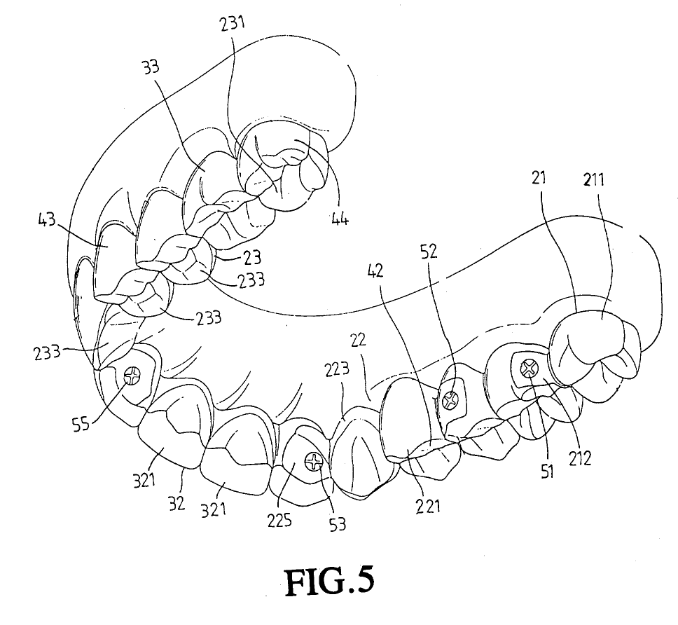

As shown in FIGS. 4 and 5 which show yet another embodiment of the present invention and comprises two lingual restorations 2 and a buccal restoration 3. The lingual restorations 2 are made by metal material and can be used for the situations of missing one tooth, two and four teeth. The first lingual restorations 2 for the situation of two teeth missing are made in one-piece and includes a undercut 211 which is shaped corresponding to the contour of the lingual teeth side of the lingual side and the occusal plane, and a connection portion 212 which is located adjacent to the connection portion 212. The undercut 211 is mounted to the nature teeth 41 and the connection portion 212 has a threaded hole 213. For the second lingual restoration 22 in the situation of four teeth missing, besides the undercut 221 and the connection portion 22, another undercut 224 with a protrusion 223 and a connection portion 225 are formed in the undercut 221 in sequence. The nature teeth 42 has a notch 421 so as to be matched with the protrusion 223 so as to connect the lingual restoration 22 and the nature teeth 42. For the third lingual restoration 22 for one tooth missing, besides the undercut 231 and the connection portion 232, a pre-determined number of undercuts 233 are defined in an end of the connection portion 232. A protrusion is formed on an inside of the undercut located at the side of the third lingual restoration 23. A notch 431 is defined in the nature tooth 43 so as to be engaged with the protrusion 234 in the undercut 233.

For the first buccal restoration 31 includes two positioning grooves 311, 312 and a threaded hole 313 is defined in the two positioning grooves 311 so as to cooperate with the two respective threaded holes 213 in the connection portion 212 and the threaded hole 226 in the connection portion 222 of the second lingual restoration 22. Two wings 314 extend from two ends of the first lingual restoration 31 and contact against the insides of the two nature teeth 42. The first lingual restoration 31 is engaged with the nature teeth and the two connection portions 212, 222 are inserted in the positioning grooves 311, 312. Two screws 51, 52 threadedly engage with the two threaded holes 213, 313 of the first lingual restoration 21 and the buccal restoration and the two threaded holes 226, 313 of the second lingual restoration 21 and the first buccal restoration 31 from inside of the mouth toward outside, the wings 314 of the first buccal restoration 31 contact the nature teeth 41, 42. This ensures the first lingual restoration 21, the second lingual restoration 22 and the first buccal restoration are firmly connected to the nature teeth 41, 42 without interspace as shown in FIG. 5. For the second buccal restoration 32 for the place where four teeth are missing, extra dentures are needed because the space of the missing teeth is large. The connection by the screw 53 makes the second lingual restoration 22 and the second buccal restoration each have a wing 322 at one end thereof so as to contact the nature teeth 42, 43. The second buccal restoration cannot pass through the area where the teeth are missing so that no intersapce is defined as shown in FIG. 5. For the third buccal restoration 33 for the place where one tooth is missing, the third buccal restoration 33 has two wings 331 at two ends thereof and the two wings 331 contact the nature teeth 43, 44. The difference from the first buccal restoration 31 is that the positioning grooves 332 at the two sides thereof become a single space such that the third buccal restoration 33 can be connected to the connection portion 232 of the third lingual restoration 23 by the single space 332. The wings 331 contact the adjacent nature teeth 43, 44 and the screw 54 makes the third lingual restoration 23 to the third buccal restoration 33 be secured to the nature teeth 43, 44. Another screw 55 connects the third lingual restoration and the second buccal restoration 32 together as shown in FIG. 5.

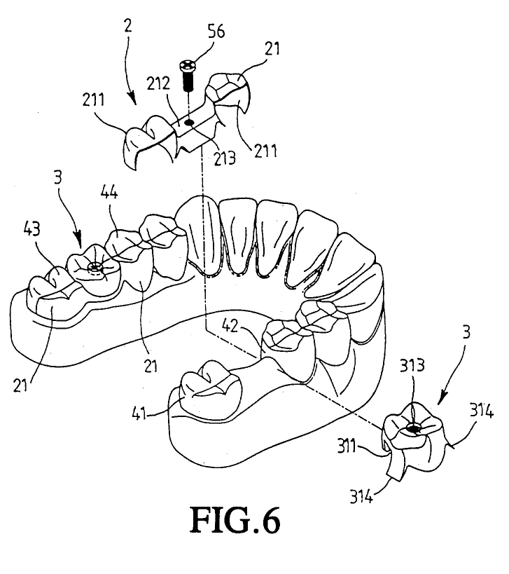

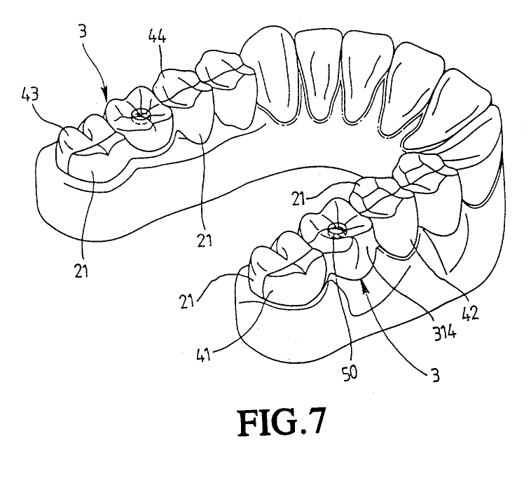

FIGS. 6 and 7 show the buccal restoration 3 has positioning grooves 311, wings 314 and the threaded hole 313. The lingual restoration 2 has a first lingual restoration 21 and a undercut 211 is defined from inside of the first lingual restoration 21. The connection portion 212 is connected to the positioning grooves 311 of the buccal restoration 3 can be connected with each other by a screw 56. The undercut 211 is matched with the occusal surface of the nature teeth and the buccal restoration 3 has wings 314 on its two ends and the wings 314 contact the nature teeth 41, 42. A filling 50 can be used to fill the notch of the connection area of the screw 56.

The lingual restorations and the buccal restoration are connected by the screw and the lingual restorations have an undercut to match with the nature teeth such that the force can be dispensed by the nature teeth. This protects the screw and the denture which is not descended or hurts the gingiva. The damage for the nature teeth is reduced to 0.2 mm to 0.5 mm only so that the time consuming is effectively reduced and no local anesthesia is necessary. The buccal restoration has a contour that is matched with the curved contour of the inside of the nature teeth (mesio-distal side). The two wings of the buccal restoration are engaged with the contour of the nature teeth and the occusal plane can be maintained. When using the teeth and the dentures, the screw is used only for connection and does not completely bear the force so that it improves the shortcomings of the conventional dentures.

While we have shown and described the embodiment in accordance with the present invention, it should be clear to those skilled in the art that further embodiments may be made without departing from the scope of the present invention.

What is claimed is:

1. An assembly of denture bridge comprising:
two lingual restorations and a buccal restoration, one of the lingual restorations having at least one undercut which is adapted to be matched with nature teeth located beside the missing teeth, the top of the restorations including an occusal surface that is adapted to be shaped to correspond the occusal plane of the nature teeth, the buccal restoration having a positioning groove and two wings connected to the buccal restoration so as to be adapted to contact the nature teeth, a connection portion of the lingual restorations and the positioning groove connected with each other.

2. The assembly as claimed in claim 1, wherein the at least one undercut is shaped to matched with the lingual surface of the nature teeth, the mesio-distal side and the occusal surface, the other lingual restoration having two wings and an undercut which is matched with the mesio-distal side so as to contact the sides of the nature teeth, the undercut and the wings prevent the lingual restorations from being shifted toward the lingual surface or upwards, the two lingual restorations and the buccal restoration connected by a screw.

3. An assembly of a denture bridge, comprising:
at least one lingual restoration having a undercut and a connection portion which is located adjacent to the undercut, the undercut adapted to be mounted to the nature teeth and a threaded hole defined through the connection portion;
at least one buccal restoration having two positioning grooves and a threaded hole defined in each of the positioning grooves, the threaded holes of the positioning grooves located corresponding to the threaded hole in the connection portion, two wings connected to two ends of the buccal restoration and adapted to contact insides of the nature teeth, the connection portion inserted in the positioning groove and a screw threadedly connecting the threaded holes in the connection portion and the grooves.

4. The assembly as claimed in claim 1 or 3, wherein a undercut with a protrusion are formed in the undercut of the lingual restoration and a notch adapted to be defined in the nature tooth which is located corresponding to the protrusion, the protrusion engaged with the notch, the connection portion with the threaded hole being connected to the positioning groove of the buccal restoration and a screw connecting the threaded hole in the connection portion and the grooves.

5. The assembly as claimed in claim 1 or 3, the lingual restoration has a predetermined number of undercuts in an end the connection portion, the buccal restoration having two wings at two ends thereof and the wings adapted to contact nature teeth, the positioning grooves being made to be a single space such that the buccal restoration is connected to the connection portion, a screw connecting the lingual restoration and the buccal restoration.

6. The assembly as claimed in claim 1 or 3, wherein one of the lingual restorations has a undercut from which a protrusion extends and a notch is adapted to be defined in the nature tooth, the protrusion engaged with the notch.

7. The assembly as claimed in claim 1 or 3, wherein the connection portion on an end of the lingual restoration is integral with the undercut so that a positioning groove of another buccal restoration is connected thereto.
